(19) United States
(12) Patent Application Publication
(10) Pub. No.: US 2020/0082643 A1
(43) Pub. Date: Mar. 12, 2020

(54) CHARGING SYSTEM, CHARGING METHOD, PROGRAM, AND WHEEL LOAD SCALE

(71) Applicant: MITSUBISHI HEAVY INDUSTRIES MACHINERY SYSTEMS, LTD., Kobe-shi, Hyogo (JP)

(72) Inventors: Hiroyuki NAKAYAMA, Tokyo (JP); Kenta NAKAO, Tokyo (JP); Takaaki SUNAGAWA, Kobe-shi (JP); Koichi KANEHARA, Kobe-shi (JP)

(21) Appl. No.: 16/467,205

(22) PCT Filed: Dec. 14, 2016
(86) PCT No.: PCT/JP2016/087195

§ 371 Date: Jun. 6, 2019

(51) Int. Cl. G07B 15/06; G01G 19/02

(52) U.S. Cl. CPC G07B 15/06; G01G 19/025

(57) ABSTRACT

The charging system including an axle load scale configured to measure axle loads of a plurality of axles of a vehicle, an axle load scale measurement value acquisition unit configured to acquire measurement values of the axles from the axle load scale, an axle load information computation unit configured to compute a representative value of the measurement values, and a toll determination unit configured to determine a toll of the vehicle on the basis of the representative value.

### RELATED APPLICATIONS

The present application is a National Phase of International Application Number PCT/JP2016/087195 filed Dec. 14, 2016.

### TECHNICAL FIELD

The present invention relates to a charging system, a charging method, a program, and a wheel load scale.

### BACKGROUND ART

Today, a charging system used for a toll road such as a highway includes a toll determination unit and a vehicle type determination system (vehicle type determination apparatus) for determining the vehicle-type classification of traveling vehicles. In this case, the toll determination unit determines the toll (charge) associated with the vehicle-type classification determined by the vehicle type determination system.

As a technique relating to the above-mentioned configuration, Patent Document 1 discloses a charging system in which whether each vehicle is in a non-loaded state or a loaded state is determined based on the acquired axle load ratio of the front axis and the rear axis of each vehicle, and the toll associated with the vehicle-type classification for a non-loaded state or the toll associated with the vehicle-type classification for a loaded state are calculated.

### CITATION LIST

### Patent Documents

Patent Document 1: JP 2005-092283 A

### SUMMARY OF INVENTION

### Problem to be Solved by the Invention

The charging system as that disclosed in Patent Document 1 can charge the toll associated with the weight of the load for each vehicle. However, the amount of the toll is not always associated with the degree of the influence on road damage. Note that the degree of the influence on road damage is associated with the total weight, the axle load, the wheel load and the like of the vehicle (including loaded goods), for example.

In view of this, an object of the present invention is to provide a charging system, a charging method, a program and a wheel load scale that can achieve charging corresponding to the degree of the influence on road damage.

### Solution to Problem

A charging system (1, 100) according to one aspect of the present invention includes an axle load scale (21) configured to measure axle loads of a plurality of axles of a vehicle; an axle load scale measurement value acquisition unit (22A) configured to acquire measurement values of the axles from the axle load scale; an axle load information computation unit (22B) configured to compute a representative value of the measurement values; and a toll determination unit (31C, 131C) configured to determine a toll of the vehicle on a basis of the representative value.

According to the present aspect, the charging system can acquire the axle load of each axle of the vehicle and can charge the toll associated with the representative value of the axle loads of the axles. The degree of the influence of each vehicle on road damage is associated with the representative value, and therefore the charging system can charge a toll corresponding to the degree of the influence on road damage.

A charging system (200) according to one aspect of the present invention includes a wheel load scale (221) configured to measure wheel loads of a plurality of wheels of a vehicle; a wheel load scale measurement value acquisition unit (222A) configured to acquire measurement values of the wheels from the wheel load scale; a wheel load information computation unit (222B) configured to compute a representative value of the measurement values; and a toll determination unit (231C) configured to determine a toll of the vehicle on a basis of the representative value.

According to the present aspect, the charging system can acquire the wheel load of each wheel of the vehicle and can charge the toll associated with the representative value of the wheel loads of the wheels. The degree of the influence of each vehicle on road damage is associated with the representative value, and therefore the charging system can charge a toll corresponding to the degree of the influence on road damage.

The charging system according to one aspect of the present invention further includes: a vehicle information acquisition unit (11) configured to acquire vehicle information of the vehicle; a vehicle type determination unit (12) configured to determine a vehicle type of the vehicle from the vehicle information; and a weight charge determination unit (31B, 131B, 231B) configured to determine, from the vehicle type, whether the toll of the vehicle should be determined on the basis of the representative value. When it is determined that the toll of the vehicle should be determined on the basis of the representative value, the toll of the vehicle is determined by the toll determination unit.

According to the present aspect, the charging system uses the representative value to determine the toll when it is determined that the vehicle is the vehicle type that should be weight-charged. Thus, the measurement range of the axle load scale and/or the wheel load scale can be set in accordance with the weight of the vehicle type that should be weight-charged. In this manner, the measurement range can be reduced, and thus the weight measurement accuracy (resolution) can be increased, and more detailed weight charging can be achieved.

In the charging system according to one aspect of the present invention, when it is determined that the toll of the vehicle should not be determined on the basis of the representative value, the toll of the vehicle is determined on a basis of a vehicle-type classification.

According to the present aspect, the charging system uses the vehicle-type classification to determine the toll when it is determined that the vehicle type is not the vehicle type that should be weight-charged. Thus, the measurement range of the axle load scale and/or the wheel load scale can be set in accordance with the weight of the vehicle type that should be weight-charged. In this manner, the measurement range can be reduced, and thus the weight measurement accuracy (resolution) can be increased, and more detailed weight charging can be achieved.

In the charging system according to one aspect of the present invention, the representative value is a maximum value or an average value of the measurement values.

According to the present aspect, the charging system determines the toll associated with the maximum value of the axle loads or the maximum value of the wheel loads and therefore can charge the toll associated with a local maximum load for each axle or for each wheel even with vehicles having the same total weight.

Further, according to the present aspect, the charging system determines the toll associated with the average value of the axle loads or the average value of the wheel loads and therefore can charge the toll associated with the number of the axles or the wheels even with vehicles having the same total weight.

A charging method according to one aspect of the present invention includes measuring axle loads of a plurality of axles of a vehicle with an axle load scale; acquiring measurement values of the axles from the axle load scale; computing a representative value of the measurement values; and determining a toll of the vehicle on a basis of the representative value.

A charging method according to one aspect of the present invention includes measuring wheel loads of a plurality of wheels of a vehicle with a wheel load scale; acquiring measurement values of the wheels from the wheel load scale; computing a representative value of the measurement values; and determining a toll of the vehicle on a basis of the representative value.

The charging method according to one aspect of the present invention further includes acquiring vehicle information of the vehicle; determining a vehicle type of the vehicle from the vehicle information; and determining, from the vehicle type, whether the toll of the vehicle should be determined on the basis of the representative value. When it is determined that the toll of the vehicle should be determined on the basis of the representative value, the toll of the vehicle is determined by the determining of the toll of the vehicle.

In the charging method according to one aspect of the present invention, the representative value is a maximum value or an average value of the measurement values.

A program according to one aspect of the present invention is configured to cause a computer of a charging system including an axle load scale configured to measure axle loads of a plurality of axles of a vehicle to function as: a vehicle type information acquisition unit configured to acquire a vehicle type of the vehicle determined on a basis of vehicle information of the vehicle; an axle load information acquisition unit configured to acquire a representative value of measurement values of the axles acquired from the axle load scale; a weight charge determination unit configured to determine, from the vehicle type, whether a toll of the vehicle should be determined on a basis of the representative value; and a toll determination unit configured to determine the toll of the vehicle on the basis of the representative value when it is determined that the toll of the vehicle should be determined on the basis of the representative value.

A program according to one aspect of the present invention is configured to cause a computer of a charging system including a wheel load scale configured to measure wheel loads of a plurality of wheels of a vehicle to function as: a vehicle type information acquisition unit configured to acquire a vehicle type of the vehicle determined on a basis of vehicle information of the vehicle; a wheel load information acquisition unit configured to acquire a representative value of measurement values of the wheels acquired from the wheel load scale; a weight charge determination unit configured to determine, from the vehicle type, whether a toll of the vehicle should be determined on a basis of the representative value; and a toll determination unit configured to determine the toll of the vehicle on the basis of the representative value when it is determined that the toll of the vehicle should be determined on the basis of the representative value.

A wheel load scale (221) of a charging system according to one aspect of the present invention includes a plurality of weight detection units (221A, 221B) disposed side by side along a lane width direction for a vehicle including a plurality of wheels in the lane width direction.

According to the present aspect, the wheel load scale of the charging system can measure the wheel weight at each position in the lane width direction and therefore can measure the load of each wheel of the vehicle and can charge the toll corresponding to the degree of the influence on road damage.

A charging system (1, 100) according to one aspect of the present invention includes an axle load scale (21) configured to measure axle loads of a plurality of axles of a vehicle; an axle load scale measurement value acquisition unit (22A) configured to acquire measurement values of the axles from the axle load scale; an axle load information computation unit (22B) configured to compute a sum of the measurement values; and a toll determination unit (31C, 131C) configured to determine a toll of the vehicle on a basis of the sum.

According to the present aspect, the charging system determines the toll in association with the sum of the entire axle load of the vehicle and therefore can charge the toll associated with the total weight of the vehicle. The degree of the influence on road damage of each vehicle is associated with the total weight of each vehicle, and therefore it is possible to charge the toll corresponding to the degree of the influence on road damage.

A charging system (200) according to one aspect of the present invention includes a wheel load scale (221) configured to measure wheel loads of a plurality of wheels of a vehicle; a wheel load scale measurement value acquisition unit (222A) configured to acquire measurement values of the wheels from the wheel load scale; a wheel load information computation unit (222B) configured to compute a sum of the measurement values; and a toll determination unit (231C) configured to determine a toll of the vehicle on a basis of the sum.

According to the present aspect, the charging system determines the toll according to the sum of the total wheel load of the vehicle and therefore can charge the toll associated with the total weight of the vehicle. The degree of the influence on road damage of each vehicle is associated with the total weight of each vehicle, and therefore it is possible to charge the toll corresponding to the degree of the influence on road damage.

### Advantageous Effect of Invention

According to one aspect of the present invention, charging corresponding to the degree of the influence on road damage can be achieved.

### BRIEF DESCRIPTION OF DRAWINGS

FIG. 1 is a schematic view of a charging system according to a first embodiment of the present invention.

FIG. 2 is a block diagram of the charging system according to the first embodiment of the present invention.

FIG. 3 is a top view of an axle load scale of the charging system according to the first embodiment of the present invention.

FIG. 4 is a sectional view taken along a line IV-IV of FIG. 3.

FIG. 5 is a flowchart of the charging system according to the first embodiment of the present invention.

FIG. 6 is a schematic view of a charging system according to a second embodiment of the present invention.

FIG. 7 is a block diagram of the charging system according to the second embodiment of the present invention.

FIG. 8 is a schematic view of a charging system according to a third embodiment of the present invention.

FIG. 9 is a block diagram of the charging system according to the third embodiment of the present invention.

FIG. 10 is a top view of a wheel load scale of the charging system according to the third embodiment of the present invention.

FIG. 11 is a sectional view taken along a line XI-XI of FIG. 10.

FIG. 12 is a flowchart of the charging system according to the third embodiment of the present invention.

### DESCRIPTION OF EMBODIMENTS

Embodiments of the present invention are described below with reference to the accompanying drawings.

### First Embodiment

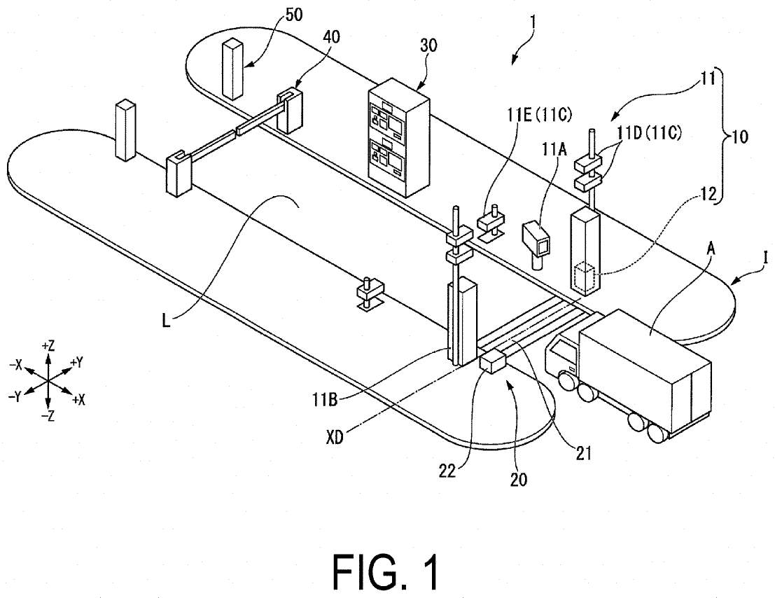

A first embodiment of the charging system according to the present invention will be described with reference to FIGS. 1 to 5.

### Overall Configuration

An overall configuration of a charging system 1 is described below.

As illustrated in FIG. 1, the charging system 1 is provided at an exit tollgate (or an entry tollgate in some types of toll systems) of a highway, which is a toll road. The charging system 1 is a facility for collecting, from a user of the highway, a toll associated with a vehicle A, in which the user is on board.

The vehicle A is traveling in a lane L in the charging system 1, which is provided at an exit tollgate. The lane L extends from the highway side to the open road side. Islands I are laid on both sides of the lane L. Various devices that constitute the charging system 1 are disposed on the islands I.

Hereinafter, the direction in which the lane L extends (±X direction in FIG. 1) is referred to as “lane direction”, and the highway side in the lane direction of the lane L (+X direction side in FIG. 1) is referred to as “upstream side”. In addition, the open road side (−X direction side in FIG. 1) in the lane direction of the lane L is referred to as “downstream side”.

Further, the width direction of the lane L is referred to as “lane width direction” (±Y direction in FIG. 1), and the vehicle height direction of the vehicle A is referred to as “height direction” (±Z direction in FIG. 1).

As illustrated in FIG. 1, the charging system 1 includes a vehicle type determination apparatus 10, an axle load information processing apparatus 20, an automatic toll collection machine 30, a start control machine 40, and a start side vehicle detector 50.

The vehicle type determination apparatus 10 is disposed on the upstream side of the lane L and includes a variety of detection sensors disposed on the islands I. The variety of detection sensors are described later.

The vehicle type determination apparatus 10 determines the vehicle-type classification (e.g. “compact vehicle or two-wheeled vehicle”, “standard vehicle”, “intermediate vehicle”, “large vehicle”, “oversize vehicle” and the like) as the vehicle type of the vehicle A traveling in the lane L on the basis of information obtained by the variety of sensors.

The axle load information processing apparatus 20 handles axle load information of the vehicle A traveling in the lane L.

The axle load information processing apparatus 20 is disposed on the upstream side of the lane L and includes an axle load scale 21 disposed on the lane L. The axle load scale 21 is described later.

The automatic toll collection machine 30 is a machine that displays the toll amount and the like to the driver and the like (the user) of the vehicle A traveling in the lane L, and performs the toll collection process. A display that displays the toll amount, receiving slots for receiving bills, coins, credit cards and/or the like, and the like are disposed on the front side (the side facing the lane L) of the automatic toll collection machine 30.

The automatic toll collection machine 30 is disposed downstream of the vehicle type determination apparatus 10 on the island I and charges an amount associated with the vehicle A.

The start control machine 40 is a machine that is disposed downstream of the automatic toll collection machine 30 and controls the start of the vehicle A traveling in the lane L. For example, the start control machine 40 closes the lane L to restrict the vehicle A from starting until the driver or others of the vehicle A having entered the lane L completes payment of the required amount through the automatic toll collection machine 30. Upon completion of the payment, the lane L is opened to allow the vehicle A to exit.

The start side vehicle detector 50 is disposed most downstream of the lane L and detects the exit of the vehicle A from the charging system 1.

### Vehicle Type Determination Apparatus

The vehicle type determination apparatus 10 is described in detail below.

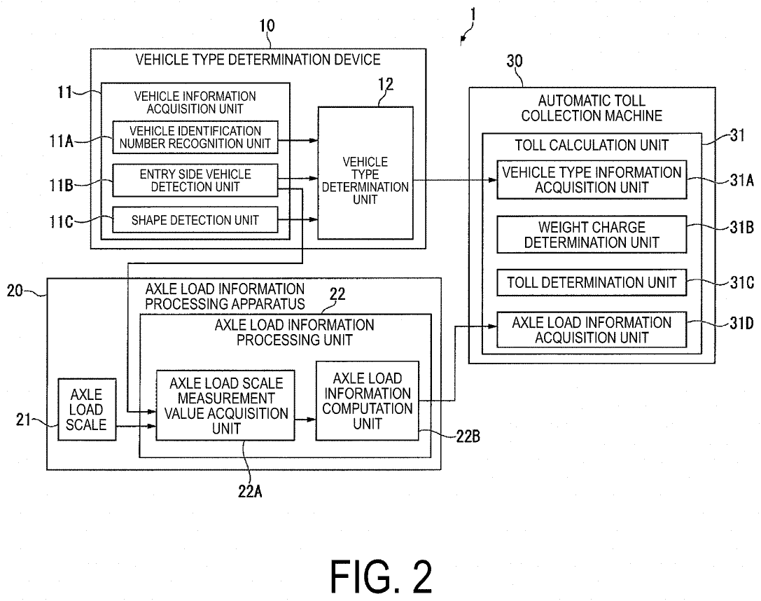

As illustrated in FIGS. 1 and 2, the vehicle type determination apparatus 10 includes a vehicle information acquisition unit 11 and a vehicle type determination unit 12.

The vehicle information acquisition unit 11 includes a variety of detection sensors, namely, a vehicle identification number recognition unit 11A, an entry side vehicle detector 11B, and a shape detection unit 11C.

The vehicle type determination unit 12 determines the vehicle-type classification of the vehicle A on the basis of vehicle information acquired by the variety of detection sensors of the vehicle information acquisition unit 11.

From the front side (downstream side), the vehicle identification number recognition unit 11A performs imaging of the vehicle body of the vehicle A arriving at a predetermined position (position XD) in the lane direction, and recognizes license plate information including “identification number”, “plate size”, “classification number”, “plate color” and the like on the basis of the image data obtained by the imaging.

Through a light-projecting tower and a light-receiving tower, which are disposed on islands I so as to face each other in the lane width direction (±Y direction) with the lane L therebetween, the entry side vehicle detector 11B determines the presence or absence of the vehicle A (vehicle body) traveling in the lane L to detect, as vehicle passage information, passage (entry) of a predetermined position (position XD) of one vehicle A.

The shape detection unit 11C generates shape information of the traveling vehicle A on the basis of a plurality of detection signals acquired through a vehicle height detector 11D and a vehicle length detector 11E. The shape information is information based on at least the vehicle height and the vehicle length of the vehicle body of the vehicle A.

Through the light projector and the light receiver, which are disposed on the islands I and located at a predetermined height (±Z direction), the vehicle height detector 11D outputs a detection signal relating to the presence/absence of the vehicle body of the vehicle A traveling in the lane L.

The vehicle length detector 11E is disposed downstream of the entry side vehicle detector 11B by a predetermined distance in the lane direction, and outputs, through the light projector and the light receiver facing each other in the lane width direction with the lane L therebetween, a detection signal relating to the entry/exit of the vehicle A traveling in the lane L at the location where the vehicle length detector 11E is disposed.

With reference to the detection signal representing the presence/absence of the vehicle A from the vehicle height detector 11D, the shape detection unit 11C generates, as vehicle height information, information representing whether the vehicle height of the vehicle A has reached a predetermined height.

In addition, with reference to the detection signal representing the presence/absence of the vehicle A from the vehicle length detector 11E, the shape detection unit 11C generates, as vehicle length information, information representing whether the vehicle length of the vehicle A has reached a length relating to the predetermined distance.

The vehicle type determination unit 12 manages the entire operation of the vehicle type determination apparatus 10. Specifically, the vehicle type determination unit 12 receives a detection signal (information) from the entry side vehicle detector 11B, and information from the shape detection unit 11C, information of the vehicle identification number recognition unit 11A and the like, and, on the basis of the variety of information thus received, uniquely determines the vehicle-type classification of the traveling vehicle A.

In addition, the vehicle type determination unit 12 immediately notifies the determined vehicle-type classification to the automatic toll collection machine 30 as the vehicle type information. Thus, by using the notified vehicle-type classification, the automatic toll collection machine 30 can determine the toll of the vehicle A and can charge the determined toll.

While a configuration is illustrated in which the vehicle type determination unit 12 is built into the vehicle type determination apparatus 10 (e.g. the entry side vehicle detector 11B, as illustrated in FIG. 1) in the present embodiment, other embodiments are not limited this configuration. For example, in other embodiments, it is possible to adopt a configuration in which the vehicle type determination unit 12 is built into an apparatus that is not the vehicle type determination apparatus 10 and is disposed on the islands I or at a remote location such that the vehicle type determination unit 12 is connected via a communication network or the like.

### Axle Load Information Processing Apparatus

The axle load information processing apparatus 20 is described in detail below.

As illustrated in FIGS. 1 and 2, the axle load information processing apparatus 20 includes the axle load scale 21 and an axle load information processing unit 22.

The axle load scale 21 extends in the lane width direction on the road surface of the lane L. In the present embodiment, the axle load scale 21 is embedded in the road surface of the lane L. The axle load scale 21 measures the axle load of the vehicle A having a plurality of axles for each axle through built-in axle load detection units 21A and 21B described later.

The positions of the entry side vehicle detector 11B and the axle load scale 21 are the same in the lane direction (±X direction).

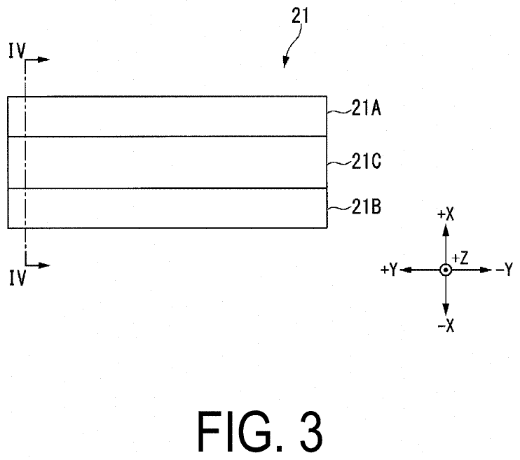

In the present embodiment, as illustrated in FIG. 3, the axle load scale 21 includes the axle load detection units 21A and 21B and a dummy unit 21C. The axle load detection units 21A and 21B are disposed side by side along the lane direction with the dummy unit 21C therebetween. Each of the dummy unit 21C, the axle load detection unit 21A and the axle load detection unit 21B is configured to extend in the lane width direction on the road surface of the lane L. The axle load detection unit 21A is disposed on the entry side relative to the axle load detection unit 21B in the lane direction.

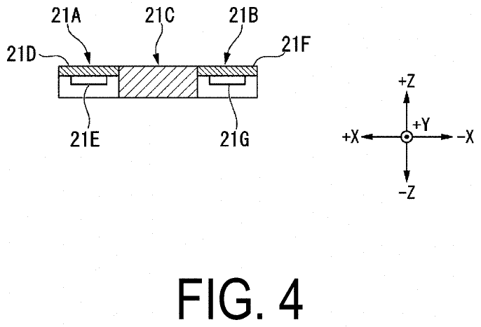

In the present embodiment, as illustrated in FIG. 4, the axle load detection unit 21A includes a tread board 21D and a strain gauge 21E disposed under the tread board 21D. Likewise, the axle load detection unit 21B includes a tread board 21F and a strain gauge 21G disposed under the tread board 21F. Each of the tread boards 21D and 21F is a long plate extending in the whole length of the width of the lane L in the lane width direction, and the plate surfaces of the plate face the upper side and the lower side.

The axle load detection unit 21A detects a load exerted on the tread board 21D with the strain gauge 21E to measure the axle loads of the vehicle A. Likewise, the axle load detection unit 21B detects a load exerted on the tread board 21F with the strain gauge 21G to measure the axle loads of the vehicle A.

The axle load information processing apparatus 20 detects measurement values of the axle load detection units 21A and 21B, and detects the presence/absence of treading of the wheels of the axles of the vehicle A on the basis of the detection timings of the measurement values.

The axle load detection units 21A and 21B are disposed side by side along the lane direction. Thus, the axle load information processing apparatus 20 can determine the forward and backward traveling of the vehicle A by comparing the timing detected based on the axle load detection unit 21A and the timing detected based on the axle load detection unit 21B on the basis of the timing of the treading of the wheel of each axle of the vehicle A.

As a modification, the axle load information processing apparatus 20 may determine the number of the axles of the vehicle A on the basis of the number of times of the treading of the wheel of the vehicle A. By notifying the information of the determined number of the axles of the vehicle A to the vehicle type determination apparatus 10, the vehicle type determination apparatus 10 can determine the vehicle type of the vehicle A in accordance with the notified number of the axles of the vehicle A.

As illustrated in FIG. 2, the axle load information processing unit 22 includes an axle load scale measurement value acquisition unit 22A and an axle load information computation unit 22B.

The axle load scale measurement value acquisition unit 22A acquires the measurement value of at least one of the axle load detection units 21A and 21B. The axle load scale measurement value acquisition unit 22A acquires vehicle passage information detected by the entry side vehicle detector 11B and acquires the measurement value of each axle load of the vehicle A while the passage of the vehicle A is being detected by the entry side vehicle detector 11B.

Thus, the axle load scale measurement value acquisition unit 22A acquires the measurement value of the axle load of each axle of one vehicle A having a plurality of axles, separately from preceding vehicles, succeeding vehicles and the like.

In the present embodiment, the entry side vehicle detector 11B is configured to detect not only a towed vehicle and a towing vehicle, but also a towing part connecting the towing vehicle and the towed vehicle, and thus detects the vehicle passage information of the towing vehicle including the towed vehicle as one vehicle. Thus, the axle load scale measurement value acquisition unit 22A acquires the measurement value of each axle of the towing vehicle including the towed vehicle as one vehicle.

The axle load information computation unit 22B computes a representative value of the acquired measurement values of the axles of one vehicle A. In the present embodiment, the axle load information computation unit 22B computes a maximum value as the representative value and notifies the maximum value to the automatic toll collection machine 30.

Thus, the axle load information processing apparatus 20 notifies, to the automatic toll collection machine 30, the axle load information having most significant influence on road damage in the acquired axle load information of the axles of the vehicle A.

As a modification, the axle load information computation unit 22B may compute an average value, a center value or the like as the representative value.

The axle load information computation unit 22B immediately notifies the computed representative value (maximum value) to the automatic toll collection machine 30. Thus, by using the notified representative value, the automatic toll collection machine 30 can determine the toll of the vehicle A and can charge the determined toll.

The representative value of the measurement values of the axles of each vehicle can be used for comparing the influence of each vehicle on road damage with that of another vehicle A. Specifically, regarding vehicles having the same total weights, a vehicle having a larger maximum value, average value, and/or the like of the axle load has a greater influence on road damage in comparison with a vehicle having a smaller maximum value, average value, and/or the like of the axle load. Therefore, the automatic toll collection machine 30 can charge the toll corresponding to the degree of the influence on road damage by calculating the toll by using the representative value of the measurement values of the axles of each vehicle.

While the axle load information processing unit 22 is disposed at a position near the axle load scale 21 in FIG. 1 in the present embodiment, other embodiments are not limited to this configuration. For example, in other embodiments, it is possible to adopt a configuration in which the axle load information processing unit 22 is built into the axle load scale 21, or built into an apparatus that is not the axle load information processing apparatus 20 and is disposed at a remote location such that the axle load information processing unit 22 is connected via a communication network or the like.

### Automatic Toll Collection Machine

The automatic toll collection machine 30 is described in detail below.

The automatic toll collection machine 30 includes a toll calculation unit 31.

The toll calculation unit 31 includes a vehicle type information acquisition unit 31A, a weight charge determination unit 31B, a toll determination unit 31C, and an axle load information acquisition unit 31D. In the present embodiment, by executing a program described later, a computer is caused to function as the vehicle type information acquisition unit 31A, the weight charge determination unit 31B, the toll determination unit 31C, and the axle load information acquisition unit 31D. The vehicle type information acquisition unit 31A acquires a vehicle-type classification determined and notified by the vehicle type determination unit 12. The axle load information acquisition unit 31D acquires a representative value notified from the axle load information computation unit 22B. On the basis of the vehicle-type classification determined by the vehicle type determination unit 12, the weight charge determination unit 31B determines whether the vehicle is the vehicle type that should be weight-charged (whether the toll of the vehicle A should be determined based on the representative value).

As described later, the toll determination unit 31C determines the toll of the vehicle A on the basis of at least one of the vehicle-type classification and the representative value.

The weight charge determination unit 31B and the toll determination unit 31C are described in detail below.

Regarding compact vehicles, two-wheeled vehicles, standard vehicles and the like, the proportion of the weight that is varied by loaded goods and/or the number of the passengers is relatively small. Regarding intermediate vehicles, large vehicles, oversize vehicles and the like, on the other hand, the proportion of the weight that is varied by loaded goods and/or the number of the passengers is relatively large.

Accordingly, in the present embodiment, the weight charge determination unit 31B determines that compact vehicles, two-wheeled vehicles, standard vehicles and the like are not the vehicle type that should be weight-charged, and determines that intermediate vehicles, large vehicles, oversize vehicles and the like are the vehicle type that should be weight-charged.

When it is determined that the vehicle is not the vehicle type that should be weight-charged, the toll determination unit 31C charges the amount associated with the vehicle type. When it is determined that the vehicle is the vehicle type that should be weight-charged, the toll determination unit 31C adds (weight charges) an additional amount associated with the representative value to the vehicle-type charge.

In particular, in the present embodiment, the toll determination unit 31C increases the additional amount as the maximum value increases on the assumption that the larger the local load, the greater the influence on road damage.

As a modification, the toll determination unit 31C may determine a toll associated with the traveled distance of the vehicle A on the toll road by acquiring the traveled distance. In this case, when it is determined that the vehicle is not the vehicle type that should be weight-charged, the toll determination unit 31C determines the toll associated with the vehicle type and the traveled distance, whereas when it is determined that the vehicle is the vehicle type that should be weight-charged, the toll determination unit 31C determines the toll associated with the vehicle type, the representative value and the traveled distance.

### Charging Method

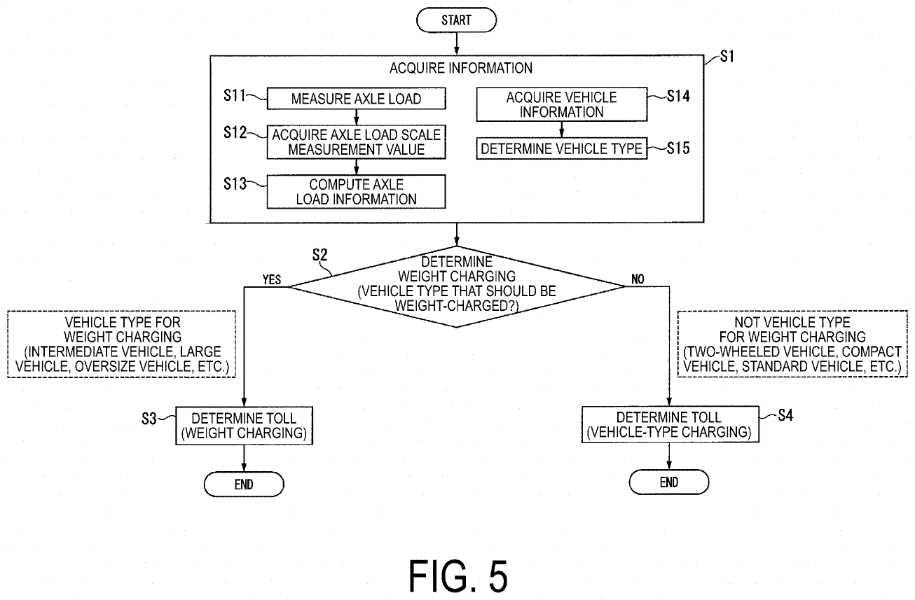

Now a charging method of the charging system 1 is described with reference to FIG. 5.

First, the charging system 1 acquires information on the vehicle A entering a tollgate (S1: information acquisition step) and determines whether the toll of the vehicle A should be determined based on the representative value (whether the vehicle is the vehicle type that should be weight-charged) in accordance with the vehicle-type classification (S2: weight charge determination step).

When it is determined that the toll of the vehicle A should be determined based on the representative value (S2: YES), the charging system 1 determines the toll of the vehicle A on the basis of the representative value (S3: toll determination step (weight charging)).

When it is determined that the toll of the vehicle A should not be determined based on the representative value (S2: NO), the charging system 1 determines the toll of the vehicle A on the basis of the vehicle-type classification (S4: toll determination step (vehicle-type charging)).

The information acquisition step S1 is described in detail below.

The information acquisition step S1 includes a process of the axle load information processing apparatus 20 and a process of the vehicle type determination apparatus 10.

In the process of the axle load information processing apparatus 20, first, the axle load scale 21 measures the axle loads of the axles of the vehicle A (S11: axle load measurement step). Subsequently, the axle load scale measurement value acquisition unit 22A acquires the axle loads of the wheels of the vehicle A from the axle load scale 21 as measurement values (S12: axle load scale measurement value acquisition step) and computes a representative value of the measurement values (S13: axle load information computation step).

In the process of the vehicle type determination apparatus 10, the vehicle information acquisition unit acquires the vehicle information of the vehicle (S14: vehicle information acquisition step) and determines the vehicle-type classification as the vehicle type on the basis of the vehicle information (S15: vehicle type determination step).

In the information acquisition step S1, the process of the axle load information processing apparatus 20 (the processes of S11 to S13) and the process of the vehicle type determination apparatus 10 (the processes of S14 and S15) may be simultaneously performed, or serially performed. In the case that the processes are serially performed, the process of the vehicle type determination apparatus 10 may be performed after the process of the axle load information processing apparatus 20, or the process of the axle load information processing apparatus 20 may be performed after the process of the vehicle type determination apparatus 10.

### Operation and Effect of Charging System

The operation and effect of the charging system 1 are described below.

In the present embodiment, the charging system 1 can acquire the axle loads of the axles of the vehicle A and can charge the toll associated with the representative value of the axle loads of the axles. The degree of the influence of each vehicle on road damage is associated with the representative value, and therefore the charging system 1 can charge the toll corresponding to the degree of the influence on road damage.

In particular, in the present embodiment, the charging system 1 determines the toll associated with the maximum value of each axle load and therefore can charge the amount associated with the local maximum load for each axle even with vehicles having the same total weight. Specifically, the charging system 1 adds an additional amount that increases as the maximum value of the axle load increases to a vehicle having a large axle load, that is, a vehicle having a large local load for each axle. For example, regarding the vehicles having the same total weight, a vehicle having a smaller number of axles and/or a vehicle having poorer front-rear loading balance has a larger local load, and therefore a higher toll is charged.

Accordingly, the greater the road damage, which leads to increase in road maintenance cost, to be caused by a vehicle, the higher the toll to be charged to the vehicle.

For example, it is assumed that a small-sized vehicle having a heavy weight causes greater damage to the road than a large vehicle having a light weight. In the related art, for example, vehicles of the same type are considered to belong to the same vehicle-type classification and are charged the same amount regardless of whether the vehicle is empty or heavily loaded. On the other hand, charging corresponding to the degree of influence on road damage (regardless of the vehicle type, size, and the like) is one conceivable method. With the present system, charging corresponding to the degree of the influence on road damage can be achieved.

Further, in the present embodiment, when it is determined that the vehicle is not the vehicle type that should be weight-charged, the toll is determined without using the representative value of the weight, whereas when it is determined that the vehicle is the vehicle type that should be weight-charged, the toll is determined using the representative value. Thus, the measurement range of the axle load scale can be reduced in accordance with the weight of the vehicle type that should be weight-charged, and therefore the weight measurement accuracy (resolution) can be increased, and, more detailed weight charging can be achieved.

### Second Embodiment

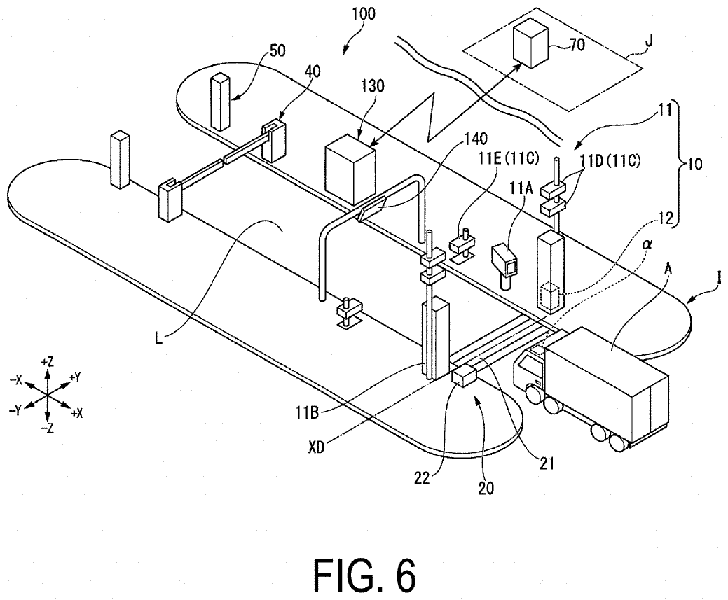

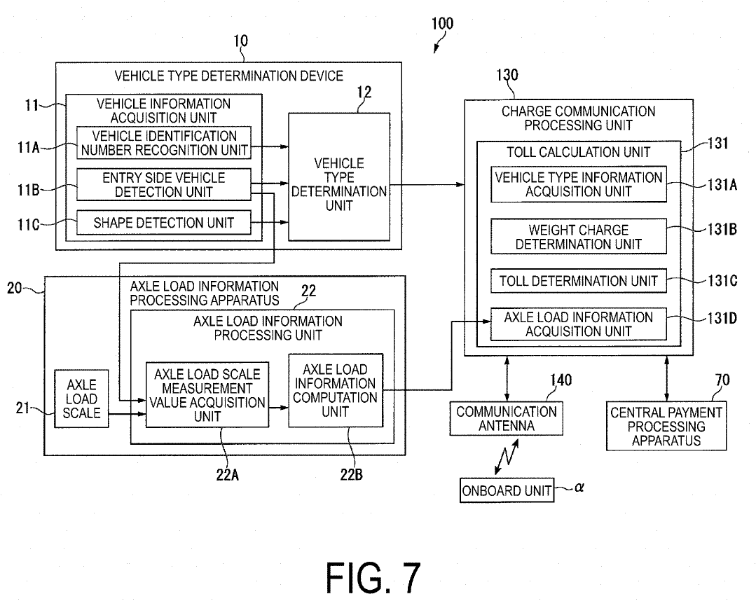

A second embodiment of the charging system according to the present invention is described below with reference to FIGS. 6 and 7.

The charging system of the present embodiment is basically identical to that of the first embodiment except in that the charging process is performed by a radio communication system, instead of the automatic toll collection machine. The differences are described in detail below.

As illustrated in FIG. 6, the charging system 100 of the present embodiment includes the vehicle type determination apparatus 10, the axle load information processing apparatus 20, a communication antenna 140, a charge communication processing unit 130, the start control machine 40, and the start side vehicle detector 50. In the charging system 100, a charging process is performed with a radio communication system (ETC, RFID and the like).

As illustrated in FIG. 7, the vehicle type determination unit 12 of the vehicle type determination apparatus 10 outputs and notifies the determined vehicle-type classification to the charge communication processing unit 130.

As illustrated in FIGS. 6 and 7, the communication antenna 140 is disposed downstream of the vehicle type determination apparatus 10 and performs a radio communication process (hereinafter referred to simply as “radio communication”) with an onboard unit α of the vehicle A. Specifically, the communication antenna 140 is capable of transmitting and/or receiving an electromagnetic wave of a predetermined frequency (e.g. about 5.8 GHz) and performs radio communication with the onboard unit α mounted in the incoming vehicle A via the electromagnetic wave.

The charge communication processing unit 130 is a processing unit that manages a series of charging processes of the charging system 100. In the present embodiment, the charge communication processing unit 130 includes a toll calculation unit 131. The toll calculation unit 131 includes a vehicle type information acquisition unit 131A, a weight charge determination unit 131B, a toll determination unit 131C, and an axle load information acquisition unit 131D.

The charge communication processing unit 130 acquires vehicle type information including the vehicle-type classification of the vehicle A determined by the vehicle type determination apparatus 10 and acquires vehicle type information including the vehicle-type classification registered in the onboard unit α through the communication antenna 140 to perform the charging process associated with the vehicle A.

In addition, the charge communication processing unit 130 outputs the acquired information, the result of the charging process and the like to the central payment processing apparatus 70 (higher-level apparatus) disposed at a remote location J as illustrated in FIGS. 6 and 7.

By internal processing, the vehicle type information acquisition unit 131A acquires the vehicle-type classification registered in the onboard unit α acquired by the charge communication processing unit 130 in addition to the vehicle-type classification of the vehicle A determined by the vehicle type determination apparatus 10.

In the present embodiment, the charge communication processing unit 130 basically uses the vehicle-type classification registered in the onboard unit α acquired via the communication antenna 140 in consideration of the speed of the communication process, the determination process and/or the like. Specifically, the toll calculation unit 131 performs the weight charge determination of the weight charge determination unit 131B and the toll determination process of the toll determination unit 131C on the basis of the vehicle-type classification registered in the onboard unit α. In this case, the vehicle type information obtained by the vehicle type determination apparatus 10 is used for confirmation of the vehicle type information registered in the onboard unit α.

The processes in the weight charge determination unit 131B and the toll determination unit 131C are similar to those of the first embodiment.

Typically, in the case that the vehicle type information is determined and acquired by the vehicle type determination apparatus 10, the time taken for vehicle type determination can possibly be long and the vehicle type cannot possibly be determined in comparison with the case that the vehicle type information is acquired from the onboard unit α. In view of this, in the present embodiment, the charging system 100 performs toll calculation using the vehicle type information registered in the onboard unit α, and thus the process speed can be increased, and, the process can be stabilized.

Further, in the present embodiment, since the vehicle type information registered in the onboard unit α is confirmed with the vehicle type information acquired from the vehicle type determination apparatus 10, the charging system 100 can double-check the vehicle type and can determine the difference between the vehicle type information registered in the onboard unit α and the vehicle type information determined by the vehicle type determination apparatus 10.

While the charging system 100 of the present embodiment is of a separate-lane type laid on the islands I, the charging system 100 may be applied to a free-flow charging system as a modification.

### Third Embodiment

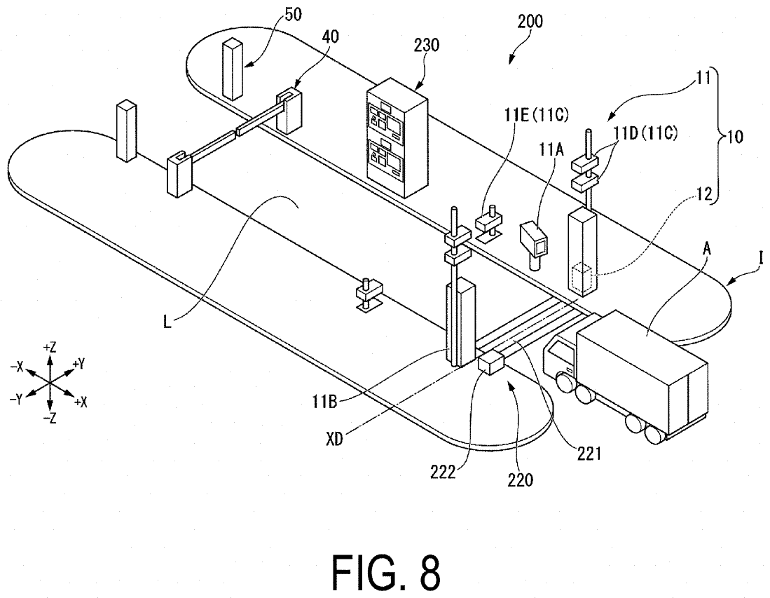

A charging system according to a third embodiment of the present invention is described below with reference to FIGS. 8 to 12.

The charging system of the present embodiment is basically identical to that of the first embodiment except in that a wheel load scale is adopted instead of the axle load scale. The differences are described in detail below.

As illustrated in FIG. 8, the charging system 200 of the present embodiment includes the vehicle type determination apparatus 10, a wheel load information processing apparatus 220, an automatic toll collection machine 230, the start control machine 40, and the start side vehicle detector 50.

The wheel load information processing apparatus 220 acquires wheel load information of the vehicle A traveling in the lane L and notifies the wheel load information to the automatic toll collection machine 230.

### Wheel Load Information Processing Apparatus

The wheel load information processing apparatus 220 is described in detail below.

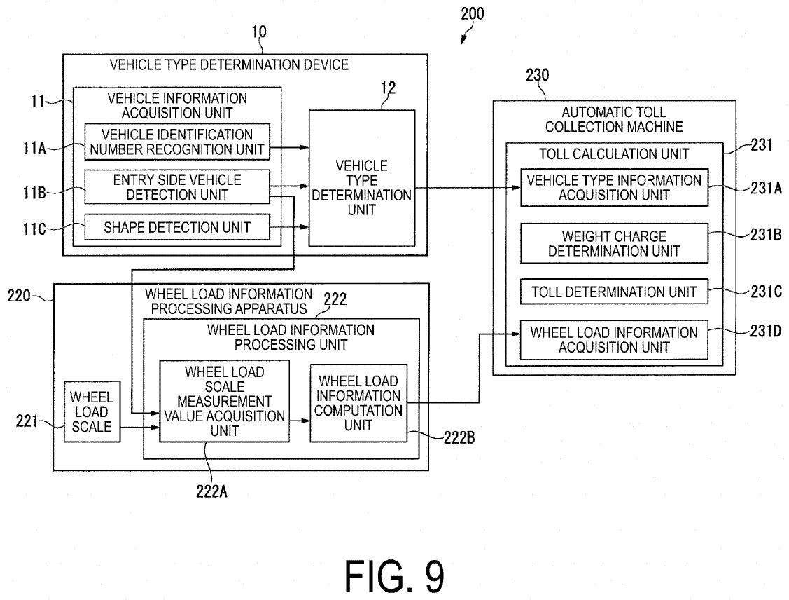

As illustrated in FIGS. 8 and 9, the wheel load information processing apparatus 220 includes a wheel load scale 221 disposed on the lane L on the upstream side of the lane L and a wheel load information processing unit 222.

The wheel load scale 221 extends in the lane width direction on the road surface of the lane L. In the present embodiment, the wheel load scale 221 is embedded in the road surface of the lane L. The wheel load scale 221 measures the wheel loads of a plurality of wheels of the vehicle A for each wheel through built-in weight detection arrays 221P and 221Q described later.

Here, the positions of the entry side vehicle detector 11B and the wheel load scale 221 are the same in the lane direction.

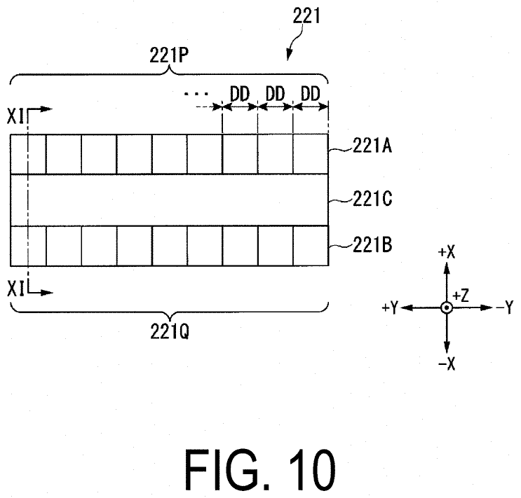

In the present embodiment, as illustrated in FIG. 10, the wheel load scale 221 includes a dummy unit 221C, the weight detection array 221P, and the weight detection array 221Q. The weight detection array 221P and the weight detection array 221Q are disposed side by side along the lane direction so as to sandwich the dummy unit 221C therebetween. Each of the dummy unit 221C, the weight detection array 221P and the weight detection array 221Q is configured to extend in the lane width direction on the road surface of the lane L. The weight detection array 221P is disposed on the entry side relative to the weight detection array 221Q in the lane direction.

In the present embodiment, as illustrated in FIG. 10, the weight detection array 221P includes a plurality of weight detection units 221A disposed side by side along the lane width direction (±Y direction) and thus forms a plurality of weight detection regions disposed side by side along the lane width direction. As illustrated in FIG. 10, in the weight detection array 221P, the plurality of divided weight detection regions is formed such that each region has a constant dividing width DD in the lane width direction.

The dividing width DD is equal to or smaller than ½ of the smallest width of the width of the space between each wheel in the lane width direction or the width of each wheel of the vehicle A, and the smaller the dividing width DD, the greater the resolution of the weight detection array 221P in the lane width direction.

Note that, in the present embodiment, in the case that the vehicle A includes a double tire, the “wheel width” means the width of one tire of the two tires of the double tire. In addition, in the case that the vehicle A includes a double tire, “the width between the wheels in the lane width direction” includes the width of the space between the two tires of the double tire.

Each weight detection unit 221A includes a tread board 221D and a strain gauge 221E. Accordingly, in association with the plurality of weight detection units 221A, a plurality of the tread boards 221D and a plurality of the strain gauges 221E are disposed side by side along the lane width direction.

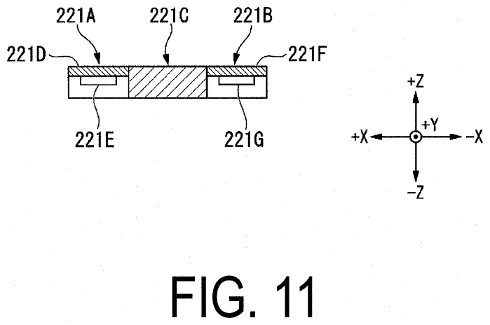

As illustrated in FIG. 11, each weight detection unit 221A includes the strain gauge 221E under the tread board 221D including a plate surface facing the height direction and detects a load exerted on the plate surface of the tread board 221D. Thus, the weight detection array 221P measures the exerted load for each weight detection region and measures the load at a resolution associated with the dividing width DD at each position in the lane width direction.

The wheel load scale 221 acquires measurement data of the load measured by the weight detection array 221P at each position in the lane width direction and measures the wheel load of each wheel.

When each wheel treads on the weight detection array 221P in the case that the width is set to the dividing width DD, each wheel simultaneously treads on a plurality of weight detection regions that are continuous in the lane width direction. Thus, the weight detection array 221P measures the wheel load of each wheel on the assumption that, of the detected measurement data of the loads at respective position, the sum of the measurement data of the loads of a plurality of weight detection regions that are continuous in the lane width direction is “wheel load of one wheel”, for example.

As with the weight detection array 221P, the weight detection array 221Q also includes a plurality of weight detection units 221B. Each weight detection unit 221B includes a tread board 221F and a strain gauge 221G. In addition, the weight detection array 221Q includes a plurality of weight detection regions as in the weight detection array 221P and measures the wheel load of each wheel.

In the present embodiment, the wheel load information processing apparatus 220 detects treading of each wheel of the vehicle A on the basis of the detection timing of the wheel load of each wheel.

In the present embodiment, the weight detection arrays 221P and 221Q are disposed side by side along the lane direction. Thus, the wheel load information processing apparatus 220 can determine the forward and backward traveling of the vehicle A by comparing the timing detected based on the weight detection array 221P and the timing detected based on the weight detection array 221Q on the basis of the timing of the treading of each wheel of the vehicle A.

As a modification, the wheel load information processing apparatus 220 may detect the number of the wheels, the tread, the tire pattern (single tire, double tire) and the like on the basis of the detected treading position and the treading timing of each wheel of the vehicle A. By notifying the above-mentioned pieces of information to the vehicle type determination apparatus 10, the vehicle type determination apparatus 10 can also determine the vehicle type of the vehicle A on the basis of the number of the wheels of the vehicle A, the tread, the tire pattern and the like notified from the wheel load information processing apparatus 220.

As illustrated in FIG. 9, the wheel load information processing unit 222 includes a wheel load scale measurement value acquisition unit 222A and a wheel load information computation unit 222B.

The wheel load scale measurement value acquisition unit 222A acquires a measurement value based on at least one of the weight detection array 221P and the weight detection array 221Q of the measurement values of the wheels detected by the wheel load scale 221. The wheel load scale measurement value acquisition unit 222A acquires the vehicle passage information detected by the entry side vehicle detector 11B and acquires the measurement value of each wheel while passage of the vehicle A is being detected by the entry side vehicle detector 11B.

The wheel load information computation unit 222B computes a representative value of the acquired measurement values of the wheels of one vehicle A.

In the present embodiment, the wheel load information computation unit 222B computes a maximum value as the representative value and therefore extracts the largest measurement value of the acquired measurement values of the wheels of one vehicle A. In this manner, in a case of a vehicle whose loading balance is poor, such as a vehicle in which the load is one-sided, the wheel load information of the wheel having most significant influence on road damage among the wheel loads of the wheels of the vehicle A is notified to the automatic toll collection machine 230.

As a modification, the wheel load information computation unit 222B may compute an average value, a center value or the like as the representative value.

The wheel load information computation unit 222B immediately notifies the computed representative value (maximum value) to the automatic toll collection machine 230. Thus, by using the notified maximum value, the automatic toll collection machine 230 can determine the toll of the vehicle A and can charge the determined toll.

While the wheel load information processing unit 222 is disposed at a position near the wheel load scale 221 in FIG. 8 in the present embodiment, other embodiments are not limited to this configuration. For example, in other embodiments, it is possible to adopt a configuration in which the wheel load information processing unit 222 is built into the wheel load scale 221, or built into an apparatus that is not the wheel load information processing apparatus 220 and is disposed at a remote location such that the wheel load information processing unit 222 is connected via a communication network or the like.

The automatic toll collection machine 230 includes a toll calculation unit 231.

The toll calculation unit 231 includes a vehicle type information acquisition unit 231A, a weight charge determination unit 231B, a toll determination unit 231C and a wheel load information acquisition unit 231D. In the present embodiment, as the toll calculation unit 231, a computer is caused to function as the vehicle type information acquisition unit 231A, the weight charge determination unit 231B, the toll determination unit 231C, and the wheel load information acquisition unit 231D by executing a program described later.

The wheel load information acquisition unit 231D acquires the representative value notified from the wheel load information computation unit 222B.

Thereafter, in the weight charge determination unit 231B and the toll determination unit 231C, processes are performed as in the first embodiment to calculate the toll.

### Charging Method

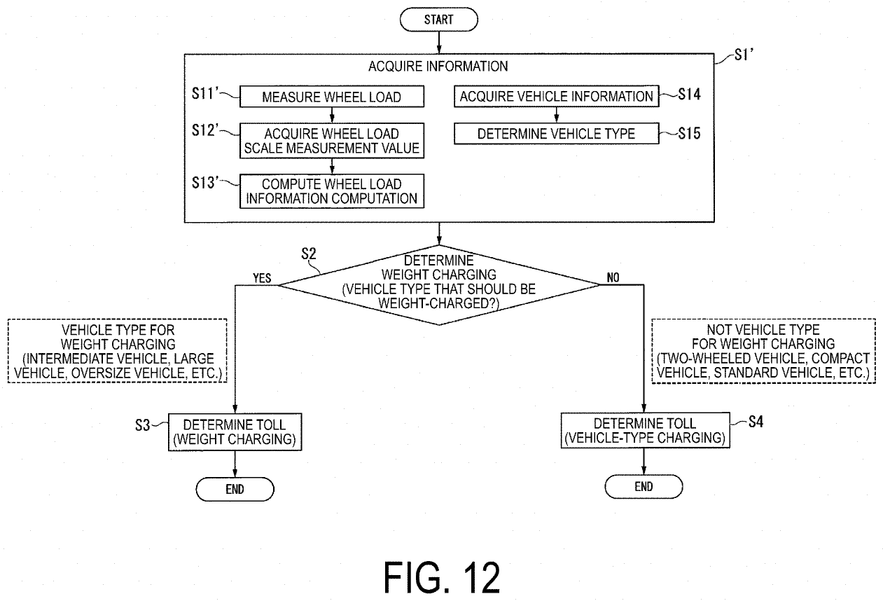

Now the charging method of a charging system 200 is described with reference to FIG. 12.

First, the charging system 200 acquires information of the vehicle A entering a tollgate (S1′: information acquisition step) and determines whether the toll of the vehicle A should be determined based on the representative value (whether the vehicle is the vehicle type that should be weight-charged) in accordance with the vehicle-type classification (S2: weight charge determination step). When it is determined that the toll of the vehicle A should be determined based on the representative value (S2: YES), the charging system 200 determines the toll of the vehicle A on the basis of the representative value (S3: toll determination (weight charging) step). When it is determined that the toll of the vehicle A should not be determined based on the representative value (S2: NO), the charging system 200 determines the toll of the vehicle A on the basis of the vehicle-type classification (S4: toll determination (vehicle-type charging) step).

The information acquisition step S1′ is described in detail below.

The information acquisition step S1′ includes the process of the wheel load information processing apparatus 220 and the process of the vehicle type determination apparatus 10.

In the process of the wheel load information processing apparatus 220, first, the wheel load scale 221 measures the wheel load of each wheel of the vehicle A (S11′: wheel load measurement step), and the wheel load scale measurement value acquisition unit 222A acquires the axle load of each wheel of the vehicle A from the wheel load scale 221 as a measurement value (S12′: wheel load scale measurement value acquisition step). Subsequently, the wheel load information computation unit 222B computes a representative value of the measurement values (S13′: wheel load information computation step).

### Operation and Effect of Charging System

The operation and effect of the charging system 200 are described below.

With the charging system 200 of the present embodiment, the wheel loads of the wheels of the vehicle A can be acquired, and the toll associated with the representative value of the wheel loads of the wheels can be charged. The degree of the influence of each vehicle on road damage is associated with the representative value, and therefore the toll corresponding to the degree of the influence on road damage can be charged.

In particular, in the charging system 200 of the present embodiment, the toll associated with a maximum value of the wheel loads is determined, and thus a toll associated with a local maximum load for each wheel can be charged even with vehicles having the same total weight. Specifically, the charging system 200 adds an additional amount that increases as the maximum value of the wheel weight increases to a vehicle having a large wheel load, that is, a vehicle having a large local load for each wheel. For example, regarding the vehicles having the same total weight, a vehicle having a smaller number of wheels and/or a vehicle having a poorer loading balance in the width direction (the lane width direction) has a larger local load, and therefore a higher toll is charged.

Accordingly, the toll of a vehicle increases as the road damage, which leads to increase in road maintenance cost, to be caused by the vehicle increases.

Additionally, as with the axle load scale of the first embodiment, the measurement range of the wheel load scale can be set in accordance with the weight of the vehicle type that should be weight-charged. In this manner, the measurement range can be reduced, and thus the weight measurement accuracy (resolution) can be increased, and, more detailed weight charging can be achieved.

In addition, in the present embodiment, the charging system 200 uses a representative value to determine the toll when it is determined that the vehicle is the vehicle type that should be weight-charged. Thus, the resolution of the wheel load scale in the lane width direction can be set in accordance with the resolution of the vehicle type that should be weight-charged. Specifically, by setting intermediate vehicles and vehicles larger than intermediate vehicles having a large wheel width in comparison with standard vehicles or vehicles smaller than standard vehicles as the vehicle type that should be weight-charged, the resolution of the wheel load scale in the lane width direction can be set in accordance with intermediate vehicles and vehicles larger than intermediate vehicles having a large wheel width. Thus, the resolution of the wheel load scale in the lane width direction can be reduced in accordance with the wheel width of intermediate vehicles and vehicles larger than intermediate vehicles, and therefore the configuration of the wheel load scale can be simplified.

As a modification, in the charging system 200 of the present embodiment, a charge communication processing unit may be provided as in the second embodiment to perform a charging process by a radio communication system.

Note that, in the embodiments described above, a program for achieving various functions of the axle load information processing unit (or the wheel load information processing unit), the toll calculation unit and the vehicle type determination unit of the charging system is recorded in a computer readable storing medium, and a computer system is caused to read and execute the program that is recorded in the storage medium to implement various processes. Here, the steps of the processes of the CPU are stored in a computer readable recording medium in the form of a program, and the processes are implemented by the computer reading out and executing this program. Examples of the computer-readable recording medium include magnetic disks, magneto-optical disks, CD-ROMs, DVD-ROMs, and semiconductor memories. This computer program may be distributed to the computer on a communication line, and the computer that receives this distribution may execute the program.

In addition, the various functions of the axle load information processing unit (or the wheel load information processing unit), the toll calculation unit and the like may be provided by a plurality of devices connected by a network.

In the foregoing, certain embodiments of the present invention have been described, but these embodiments are merely illustrative and are not intended to limit the scope of the invention. These embodiments may be implemented in various other forms, and various omissions, substitutions, and alterations may be made without departing from the gist of the invention. These embodiments and modifications are included in the scope and gist of the invention and are also included in the scope of the invention described in the claims and equivalents thereof.

For example, while a charging system for the toll amount of a toll road is described in the present embodiment, the present embodiment may be applied to a charging system for the parking toll of a parking lot.

In the present embodiment, the charging system determines the toll of the vehicle A on the basis of the representative value of the axle loads of the axles. At this time, in view of the fact that the product of the average value of the axle loads of the vehicle A and the number of the axles is the total weight of the vehicle A, the charging system may determine the toll on the basis of the total weight.

Specifically, the charging system is configured to notify, to the automatic toll collection machine, the average value (measurement values) of the axle loads of the axles of the vehicle A from the axle load information computation unit, and the number of the axles of the vehicle A from the axle load information processing apparatus or the vehicle type determination apparatus. Here, the charging system is configured such that the automatic toll collection machine uses the product of the average value of the axle loads and the number of the axles as the total weight to determine the toll associated with the total weight.

Likewise, the charging system may determine the toll associated with the total weight of the vehicle A in view of the fact that the product of the average value of the wheel loads of the vehicle A and the number of the wheels is the total weight of the vehicle A.

In the present embodiment, the charging system determines the toll of the vehicle A by acquiring the representative value of the measurement values of each axle of the vehicle A acquired from the axle load scale. As a modification, the toll of the vehicle A may be determined by acquiring the sum (total) of the axle loads of the axles of the vehicle A, instead of the representative value of the axle loads of the axles.

In this case, the charging system can charge a toll associated with the total weight of the vehicle A by determining the toll of the vehicle A on the basis of the sum of the entire axle load of the vehicle A instead of the representative value of the axle loads of the axles in the axle load information computation unit. The degree of the influence on road damage of each vehicle is associated with the total weight of each vehicle, and therefore the charging system can charge the toll corresponding to the degree of the influence on road damage.

Likewise, as another modification, the charging system may determine the toll of the vehicle A by acquiring the sum of the wheel loads of the wheels of the vehicle A instead of the representative value of the wheel loads of the wheels.

While the “wheel load scale” of the present embodiment measures the wheel load of each wheel, the sum of the wheel loads of the axles may be calculated and may be used as the “axle load scale” as a modification.

While the axle load scale and/or the wheel load scale of the present embodiment is embedded in the road surface of the lane L, the axle load scale and/or the wheel load scale may be embedded in a tread board, a tread stand and/or the like already installed on the road surface of the lane L as a modification.

While the axle load scale measurement value acquisition unit of the present embodiment acquires the measurement value of at least one of the two axle load detection units, the axle load scale measurement value acquisition unit may acquire an average value of the both measurement values of the two axle load detection units as the measurement value as a modification.

Likewise, while the wheel load scale measurement value acquisition unit acquires a measurement value based on at least one of the two weight detection arrays, the wheel load scale measurement value acquisition unit may acquire an average value of the both measurement values based on the two weight detection arrays as the measurement value as a modification.

While the axle load scale (or wheel load scale) measures the weight with two axle load detection units (or weight detection arrays) arranged in the lane direction to determine the forward and backward traveling of the vehicle A in the present embodiment, it is also possible to adopt, as a modification, a configuration including one axle load detection unit (or weight detection array) and one detection unit configured to detect the presence/absence of treading of the wheel of the vehicle A by an electrical contact. This modification can also determine the forward and backward traveling of the vehicle A on the basis of the detected timing of the treading of the wheel of the vehicle A.

### INDUSTRIAL APPLICABILITY

The charging system, the charging method, the program and the wheel load scale of the present invention can achieve charging corresponding to the degree of the influence on road damage.

1. A charging system comprising:
an axle load scale configured to measure axle loads of a plurality of axles of a vehicle;
an axle load scale measurement value acquisition unit configured to acquire measurement values of the axles from the axle load scale;
an axle load information computation unit configured to compute a representative value of the measurement values; and
a toll determination unit configured to determine a toll of the vehicle on a basis of the representative value.

2. A charging system comprising:
a wheel load scale configured to measure wheel loads of a plurality of wheels of a vehicle;
a wheel load scale measurement value acquisition unit configured to acquire measurement values of the wheels from the wheel load scale;
a wheel load information computation unit configured to compute a representative value of the measurement values; and
a toll determination unit configured to determine a toll of the vehicle on a basis of the representative value.

3. The charging system according to claim 1 further comprising:
a vehicle information acquisition unit configured to acquire vehicle information of the vehicle;
a vehicle type determination unit configured to determine a vehicle type of the vehicle from the vehicle information; and
a weight charge determination unit configured to determine, from the vehicle type, whether the toll of the vehicle should be determined on the basis of the representative value, wherein
when it is determined that the toll of the vehicle should be determined on the basis of the representative value, the toll of the vehicle is determined by the toll determination unit.

4. The charging system according to claim 3, wherein when it is determined that the toll of the vehicle should not be determined on the basis of the representative value, the toll of the vehicle is determined on a basis of a vehicle-type classification.

5. The charging system according to claim 1, wherein the representative value is a maximum value or an average value of the measurement values.

6. A charging method comprising:
measuring axle loads of a plurality of axles of a vehicle with an axle load scale;
acquiring measurement values of the axles from the axle load scale;
computing a representative value of the measurement values; and
determining a toll of the vehicle on a basis of the representative value.

7. A charging method comprising:
measuring wheel loads of a plurality of wheels of a vehicle with a wheel load scale;
acquiring measurement values of the wheels from the wheel load scale;
computing a representative value of the measurement values; and
determining a toll of the vehicle on a basis of the representative value.

8. The charging method according to claim 6 further comprising:
acquiring vehicle information of the vehicle;
determining a vehicle type of the vehicle from the vehicle information; and
determining, from the vehicle type, whether the toll of the vehicle should be determined on the basis of the representative value, wherein
when it is determined that the toll of the vehicle should be determined on the basis of the representative value, the toll of the vehicle is determined by the determining of the toll of the vehicle.

9. The charging method according to claim 6, wherein the representative value is a maximum value or an average value of the measurement values.

10. (canceled)

11. (canceled)

12. A wheel load scale of a charging system, comprising a plurality of weight detection units disposed side by side along a lane width direction for a vehicle including a plurality of wheels in the lane width direction.

13. A charging system comprising:
an axle load scale configured to measure axle loads of a plurality of axles of a vehicle;
an axle load scale measurement value acquisition unit configured to acquire measurement values of the axles from the axle load scale;
an axle load information computation unit configured to compute a sum of the measurement values; and
a toll determination unit configured to determine a toll of the vehicle on a basis of the sum.

14. A charging system comprising:
a wheel load scale configured to measure wheel loads of a plurality of wheels of a vehicle;
a wheel load scale measurement value acquisition unit configured to acquire measurement values of the wheels from the wheel load scale;
a wheel load information computation unit configured to compute a sum of the measurement values; and
a toll determination unit configured to determine a toll of the vehicle on a basis of the sum.
